(19) United States
(12) Patent Application Publication
(10) Pub. No.: US 2012/0134886 A1
(43) Pub. Date: May 31, 2012

(54) Turbulent Flow Column

(75) Inventors: Michael Schultes, Ludwigshafen (DE); Werner Grosshans, Ludwigshafen (DE)

(73) Assignee: Raschig GmbH, Ludwigshafen (DE)

(21) Appl. No.: 13/389,034

(22) PCT Filed: Aug. 4, 2010
(86) PCT No.: PCT/EP2010/004776

§ 371 Date: Feb. 6, 2012

(30) Foreign Application Priority Data
Aug. 5, 2009 (DE) 10 2009 036 144.8
Aug. 5, 2009 (DE) 20 2009 010 582.2

(51) Int. Cl. B01J 19/00

(52) U.S. Cl. 422/129

(57) ABSTRACT

A turbulent flow column for a heat and/or material exchange between a liquid phase and a flowing gaseous phase in the counter flow thereto, wherein the turbulent flow column includes at least two sections with a first layer having a high specific surface and a lower throughput capacity and a second layer arranged on top with a lower specific surface and a higher throughput capacity. The first layer of the sections of the turbulent flow column is designed for forming a turbulent flow zone, and thus a spouting bed with pourable first fillers with a high specific surface and a low throughput. The second layer of the sections is designed for forming a separating zone for the liquid phase with pourable second fillers including a lower specific surface and a higher throughput capacity compared to the first fillers of the first layer.

The invention relates to a turbulent flow column for a heat and/or mass-exchange between a liquid phase and a gaseous phase flowing in counter current thereto, wherein the turbulent flow column comprises at least two sections with a first layer having a high specific surface and a low flow capacity and a second layer arranged above having a lower specific surface and a higher flow capacity.

Such a turbulent flow column is known from WO 2006/056419 A1. In this document a turbulent flow column is described, which consists of arranged, structured packings for a heat and/or mass-exchange. The packings are arranged in layers, wherein at least one layer of the turbulent flow column has a greater density and thus a greater specific surface area compared to a layer on top having a lower specific surface area and thus a lower density. In the known turbulent flow columns the individual layers are thus formed as structured packings, wherein each individual layer of packings is arranged in a defined geometry in the column. For achieving a mass separation, the liquid phase is introduced at the top of the column and trickles downward over the packings following gravity force. A gas or steam phase is introduced at the column sump and flows upward countering the downwards trickling down liquid phase. As the gas or steam phase as well as the trickling liquid phase usually consist of a component mixing of different concentration, heat and/or mass transfer is performed due to these concentration differences between the phases, wherein the structured packings of the turbulent flow column have a high contact surface area and ensure a turbulent contact between the phases. As it is now provided that a layer of packings having a high specific surface area and a low flow capacity is arranged under the layer of packings having a lower specific surface area and a higher flow capacity, it is achieved, that the trickling liquid phase is flooded by the kinetic energy of the upward flowing gas or steam phase. By this flooding effect the contact between the liquid phase and the gas or steam phase is strongly enhanced, similar as in a turbulent fluidized bed, and thus the mass and/or heat exchange is intensified. For the known turbulent flow column, known from the document mentioned above, this is achieved by a second packing layer, lying above the first layer having a higher density, arranged in such a way that they form angular flow channels, which at their lower end, adjacent to the first layer of higher density, more vertically aligned flow channels are formed by the packing elements of the first layer, and that the flow channels of the packing elements of the second layer exhibit in their lower areas a more open cross section as in the areas of the first layer laying underneath. These layers of packings with height-variable angled flow channels should provide in combination with layers of packings of narrow geometry a significant enlarged working range, as for small package heights high performance, an optimum guided bubble regime and a low pressure drop should be achieved.

Disadvantageous at the known turbulent flow columns is the use of structured packings, as they easily and quickly contaminate, in particular when used with polluted media. Also, in a disadvantageous manner such structured packings cannot be exchanged on short term notice, as these structured packing elements must be produced accurate to size and are not available as stock items.

A further disadvantage of the use of such packing elements is to be seen in that they produce only a low pressure drop and thus can lead to an inhomogeneous flow distribution over the column cross section. Apart from that, their installation in the turbulent flow column is complex, as the structured packing elements, formed as insert elements, must be mounted in a defined orientation in the turbulent flow column.

The U.S. Pat. No. 2,271,617 describes dumped random packing elements, which at the upper as well as lower end comprises larger random packing elements as in a middle part which forms the main part of the column. By use of larger random packing elements with higher flow capacity at the upper and /or lower end of the packed section a premature flooding of the column should be prevented, which is caused by the fact, that such a packed section of random packing elements is often working either at its upper or lower end at its capacity limit, i.e. the column starts to flood in this section first.

The DE 14 44 368 describes a mass separating column having a checkered structure. The so-build chess-chart sections are provided with different random packing elements or packing geometries, so that sections with different pressure drops arise. As the gas flow follows the way of the least pressure drop, a zig-zag-like flow is achieved and thus the loading or flooding conditions are omitted.

It is object of the present invention, to further develop a turbulent flow column of the said kind, so that a simplified structure thereof is provided.

This object is solved by the invention, in that each first layer of the sections of the turbulent flow column is provided, for forming of an flooding zone and thus a bubble regime, by dumpable first random packing elements having a high specific surface and a low flow capacity, and the second layer of said sections is provided, for forming a separating zone for the liquid phase, by dumpable second random packing elements having a lower specific surface and a higher flow capacity compared to the first random packing elements of the first layer.

By measure of the invention a simplified placement of the packing elements in the turbulent flow column of the invention is achieved in an advantageous manner. One is now not forced any more—as with the known columns—to mount packing elements in the column in form of insert elements in a technically complex and time consuming manner. On the contrary, the individual layers of the turbulent flow column can be produced by inserting the corresponding random packing elements by a dumping process. A further advantage of the use of dumpable random packings instead of structured packing elements is that they produce a larger pressure loss, which leads to a homogeneous distribution of the gas or steam flow over the column cross section. This homogeneity of the gas or steam phase stabilizes the bubble regime in the flooding zone, so that in advantageous manner the flooding principle can also be used operationally safe with large column diameters. A further advantage of the use of dumpable random packing elements is that these do not contaminate as quickly as commercially available structured packing elements. In an advantageous manner, random packing elements can also be better removed from the turbulent flow column for cleaning purposes and are available as stock items, so that a short-term notice exchange can easily be performed.

An advantageous further embodiment of the invention provides that at least one insert having a porous base is arranged in the turbulent flow column. Such a measure has the advantage that hereby in a particular simple manner the individual sections of the turbulent flow column can be formed.

A further advantageous embodiment of the invention provides that at least one and preferably the first layer of at least one section of the turbulent flow column comprises reactive random packing elements. The increased liquid hold-up of the bubble regime formed in the respective layer ensures a sufficient residence time of the liquid phase for a reactive mass transfer with the reactive random packing elements, wherein the direct contact of the liquid and the reactive random packing elements and the high turbulence in the bubble regime enhances the mass transfer.

A further advantageous embodiment of the invention provides that in the second layer of at least one section of the turbulent flow column there is provided at least one downcomer. Hereby, it is achieved in an advantageous manner that the passage of the downwards trickling liquid film through this second layer is improved.

A further advantageous embodiment of the invention provides that at least a downcomer is provided with a down corner pan. By this measure of the invention it is achieved in an advantageous manner, that the lower end of the downcomer immersing in the downcomer pan is securely closed by the liquid level in the downcomer.

Further advantageous embodiments of the invention are the subject of the dependent claims.

Further details and advantages of the invention can be inferred from the preferred embodiment described in the following by the figures. It shows:

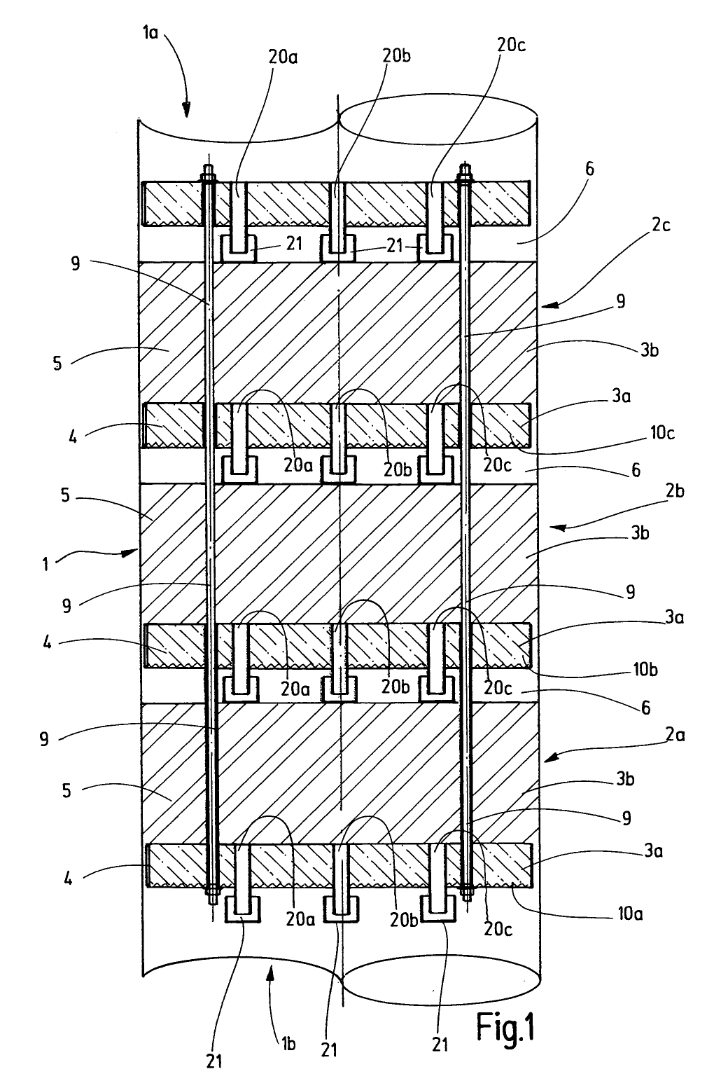

FIG. 1: a schematic view of an embodiment of a turbulent flow column,

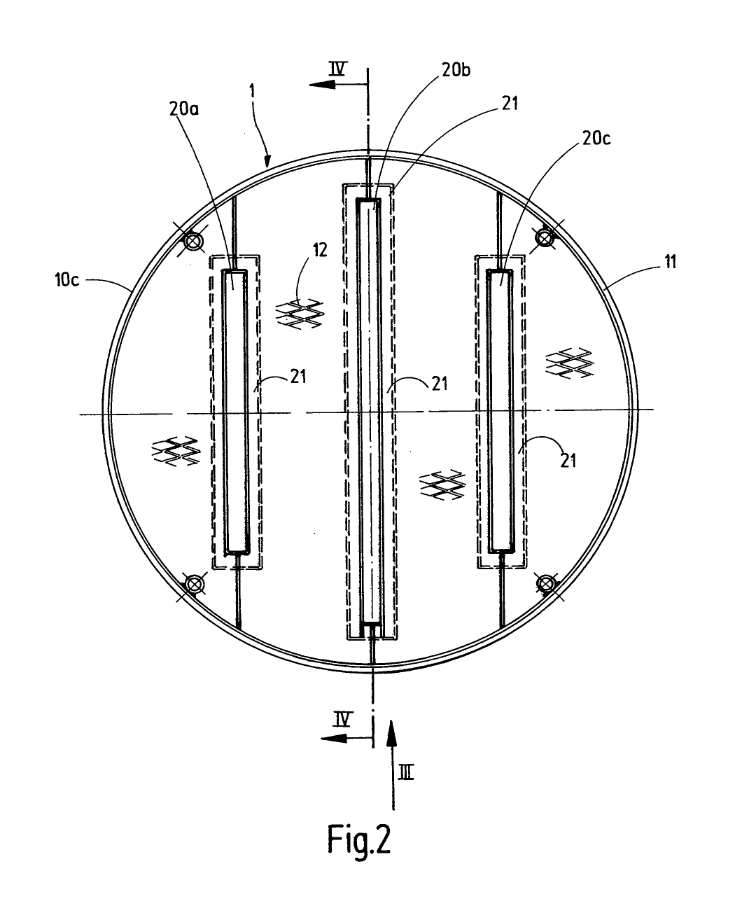

FIG. 2: a top view of the turbulent flow column of FIG. 1,

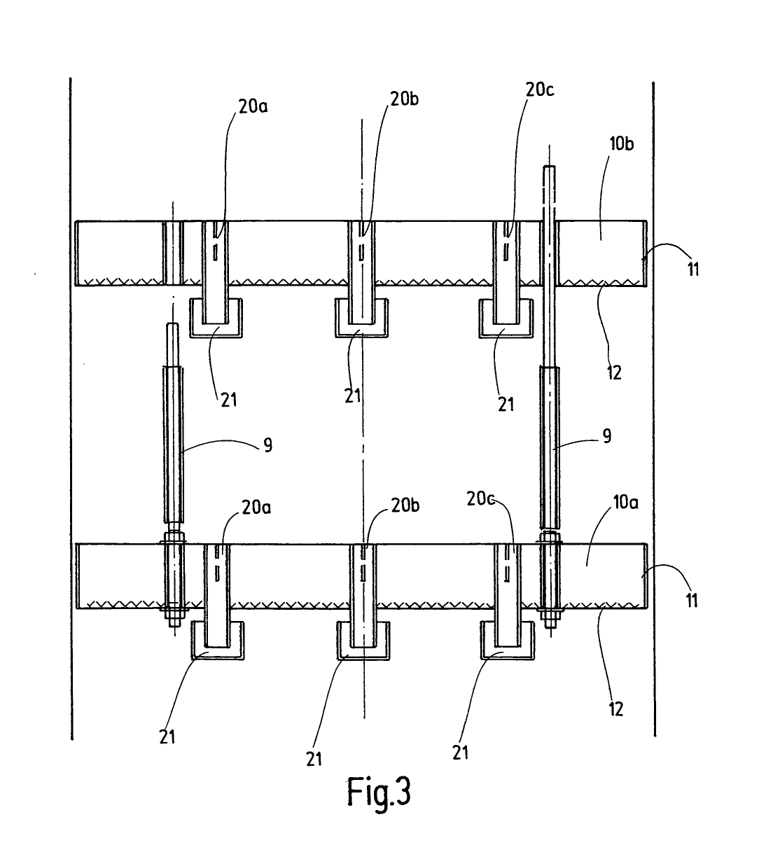

FIG. 3: a view of an insert element of the turbulent flow column seen from direction III of FIG. 2, and

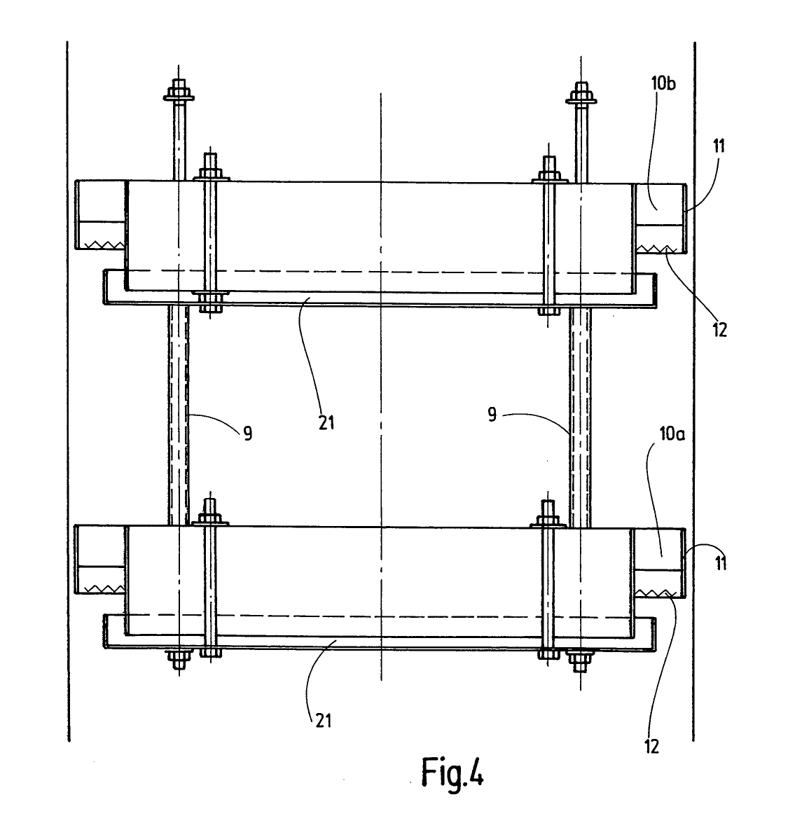

FIG. 4: a view of the insert element seen from direction IV of FIG. 2.

In FIG. 1 there is now shown schematically and in part a turbulent flow column generally designated with 1, comprising three sections 2a-2c, wherein each section consists of a first layer 3a of dumpable first random packing elements 4 and a second layer 3b of dumpable second random packing elements 5. The skilled person can easily see from the following description that the number of three sections 2a-2c of the turbulent flow column 1 shown here is only of an exemplary character and has been chosen for the purpose of a simplified description. Turbulent flow columns 1 used in practice rather show a plurality of sections 2a-2c structured as previously described. However, the number of three sections 2a-2c shown in FIG. 1 is sufficient to describe the structure and the functioning of the turbulent flow column 1.

The first layer 3a of each section 2a-2c of the turbulent flow column 1 is formed by the first random packing elements 4, which have a high specific surface and thus a low flow capacity. The second layer 3b of each section 2a-2c is formed by the second random packing elements 5, which, compared to the first random packing elements 4, have a lower specific surface and thus a higher flow capacity. For forming layers 3a, 3b the random packing elements 4 and 5 are each placed disorientated into the turbulent flow column 1 by a dumping process.

At the top of the column 1a of the turbulent flow column 1 a liquid phase is introduced in a known manner, which, by effect of gravity, flows downwards. At the column sump 1b a gas or steam phase is introduced, which flows upwards in opposite direction to the liquid phase. The random packing elements 4 of the first layer 3a of the individual sections 2a-2c form an flooding zone for the liquid phase due to their lower flow capacity and the high kinetic energy of the gas and steam phase flowing therein, so that the liquid phase in the first layers 3a is uploaded and these layers 3a are thereby flooded. This results in the forming of a bubble regime in each section 2a-2c, so that an intensive mass and/or heat exchange arises. This bubble regime extends in each of the second layers 3b of the sections 2a-2c and is again resolved therein due to the random packing elements 5 having a high flow capacity, so that the random packing elements 5 form a separating regime for the liquid phase.

The use of random packing elements 4 or 5, respectively, for forming of the flooding regime or of the separating regime, respectively, of the turbulent flow column 1 has the advantage, that these two above mentioned regimes can simply be formed by dumping alternately the first random packing elements 4 and the second random packing elements 5 in the turbulent flow column 1 for forming the first layers 3a and the second layer 3b of the individual sections 2a-2c. By use of the random packing elements 4 and 5 for the forming of the layers 3a, 3b of the individual sections 2a-2c of the turbulent flow column 1, the latter can be produced in a simple way, as now no time consuming and complex mounting of arranged, structured packing elements with defined orientation in the turbulent flow column 1 is required. Rather, the individual layers 3a, 3b can now be formed by a simple dumping of the random packing elements 4, 5. The use of random packing elements 4, 5 has the further advantage that hereby a greater pressure loss in the individual layers 3a, 3b is achieved, which leads to a more homogeneous distribution of the gaseous phase over the column cross section. This homogeneity of this phase stabilizes the bubble regime, so that the flooding principle can also be used operationally safe for large column diameters. It is a further advantage when using random packing element dumpings that, if polluted media are used, the random packing elements 4, 5 do not contaminate as quickly as those structured packing elements used up til now.

Furthermore, dumperable random packing elements 4, 5 can be taken out from the turbulent flow column 1 for cleaning purposes much better than structured packing elements.

It is preferred, that for the formation of each of the first layers 3a or of the second layers 3b, respectively, random packing elements of the applicant are used, which are known by the tradename of “Raschig Super-Ring”. Advantageously, random packing elements 4 of the applicant are used for forming the first layers 3a which have a specific surface greater than 200 m²/m³, whereas for random packing elements 5 random packing elements having a smaller specific surface as 200 m²/m³ are used. Preferred is in particular, that the ratio of the specific surfaces of the random packing elements 4 of the first layers 3a and those of the random packing element 5 of the second layer 3b is in the range between 2,5 til 5.

In order to build the turbulent flow column 1 from random packing elements 4 and 5, an insert 10a is inserted in the turbulent flow column 1 which is shown in FIGS. 3 and 4 and is described in more detail below. Then the random packing elements 4 forming the first layer 3a of the first section 2a are dumped into the turbulent flow column 1 until the first layer 3a of the first section 2a has a sufficient height. Then the second random packing elements 5 are dumped in the turbulent flow column 1 for forming the second layer 3b of the first section 2a until a sufficient thick second layer 3b has been formed. The first section 2a of the turbulent flow column 1 is therefore finished.

The described arrangement also allows in an advantageous manner to form the turbulent flow column 1 as reactive distillation column, by providing in at least one layer 3a, 3b of at least one section 2a-2c reactive random packing elements. Preferably, each first layer 3a of each section 2a-2c is provided with reactive random packing elements 4. The increased liquid content of the bubble regime in the layers 3a ensures a sufficient residence time of the liquid phase for a reactive mass transfer with the reactive random packing elements 4. The direct contact of the fluid phase and the reactive random packing elements 4 and the high turbulence of the bubble regime thereby assist in an advantageous manner the mass transfer. Such an approach has the advantage, compared to the structured packing elements used in reactive distillation methods until now, that, when trickling the random packing elements 4, no liquid film—as for the known structured packing elements, between which, as reactive solids, textile layers are arranged—is formed which encompasses the random packing elements 4 quasi-stationary.

Then a second insert 10b is inserted and the formation of the first and second layer 3a and 3b of the second section 2b is performed as previously described. As can be seen from FIG. 1, it is preferred, that the two inserts 10a and 10b are connected with each other via distance holders 9.

In the above description it is assumed, that the inserts 10a, 10b are arranged in parallel. It is also possible to arrange them in the turbulent flow column 1, up to an angle of up to 90°, twisted by orientated against each other.

The formation of the layers 3a and 3b of a third section 2c on top of the second section 2b is now performed as previously described, i.e. a third insert 10c is inserted in the turbulent flow column 1 and by dumping the random packing elements 4 and 5 the first and the second layer 3a, 3b of the third section 2c is formed. The forming of further sections is then performed as previously described.

As can be seen from FIG. 1, in the described embodiment it is provided that between the individual sections 2a-2c an intermediate space 6 free of random packing elements is provided. Such a measure has the advantage, that the resolving of the bubble regime is improved, due to the particularly open flow cross section.

FIGS. 3 and 4 now show inserts 10a, 10b, and the further inserts of the turbulent flow column 1 are preferably built in the same manner. Each insert 10a-10c comprises a circumvening edge element 11, the outer contour of which is—as it can be seen best from FIG. 2—adapted to the inner contour of the turbulent flow column 1 in such a manner that the inserts 10a-10c can be easily inserted in the turbulent flow column 1 and there is preferably a small space between the inner wall of the turbulent flow column 1 and the outer wall of the circumventing edge element 11, so that between the inner wall of the turbulent flow column 1 and the inserts 10a-10c preferably little gas and/or liquid can pass through.

A base 12 of the inserts 10a-10c is formed by a lattice, preferably by a meshed metal baffle, which is preferably welded together with the edge element 11. By forming the base 12 in such a way it is ensured that the random packing elements 4 of a first layer 3a can not mix with the random packing elements 5 of the second layer 3b of the layer above.

In FIGS. 3 and 4 again the distance holder 9 can be seen, by which the inserts 10a, 10b are connected with each other.

As it can be seen from FIGS. 1 and 2, the turbulent flow column 1 has a plurality of downcomers 20a-20c, which effect, that the downwards flowing liquid phase can penetrate more easily each of the first layer 3a of the sections 2a-2c. As can be seen from FIG. 1, it is provided in the described embodiment, that each section 2a-2c has three downcomers 20a-20c. These are advantageously formed such that the liquid phase can flow through the downcomers 20a-20c and then trickle onto the second layer 3b of the section 2b or 2a, respectively, laying underneath, but that preferably little of the upward flowing gaseous phase penetrates the downcomers 20a-20c. This is—as best shown in FIG. 3—achieved by each downcomers 20 being surrounded at its lower end by a downcomer pan 21, wherein the lower end of the downcomers 20 immerses in the down corner pan 21. This has the effect, that the downcomers 20, 2a-20c are closed by the liquid phase gathering in the down corner pan 21 and is thus gas-tight.

Summarizing, it is to be noted, that by the described measures a turbulent flow column 1 is formed, which excels by a simple production due to the use of dumpable random packing elements 4, 5 for forming the individual layers 3a, 3b of each section 2a-2c. In an advantageous manner the individual layers of the turbulent flow column 1 can be produced by inserting corresponding random packing elements 4, 5 by a dumping process. The use of random packing elements 4, 5 for forming of the layers 3a, 3b has further the advantage, that hereby a larger pressure drop is achievable, which in an advantageous manner leads to a more homogeneous distribution of the gaseous phase over the cross section of the turbulent flow column 1. The homogeneity of the gaseous phase stabilizes the bubble regime in the flooding state, so that in an advantageous manner the flooding principle can also be used reliably having large column diameters.

1. Turbulent flow column for a heat and/or mass-exchange between a liquid phase and a gaseous phase flowing in counter current thereto, wherein the turbulent flow column comprises at least two sections with a first layer having a high specific surface and a low flow capacity and a second layer arranged above having a lower specific surface and a higher flow capacity, wherein each first layer of the sections of the turbulent flow column is provided, for forming of a flooding zone and thus a bubble regime, by dumpable first random packing elements having a high specific surface and a low flow capacity, and the second layer of said sections is provided, for forming a separating zone for the liquid phase, by dumpable second random packing elements having a lower specific surface and a higher flow capacity compared to the first random packing elements of the first layer.

2. Turbulent flow column according to claim 1, wherein the specific surface of the first random packing elements is greater than 200 m²/m³.

3. Turbulent flow column according to claim 1, wherein the specific surface of the second random packing element is less than 200 m²/m³.

4. Turbulent flow column according to claim 1, wherein at least one layer of at least one section of the turbulent flow column comprises reactive random packing elements.

5. (canceled)

6. Turbulent flow column according to claim 1, wherein between two sections an intermediate space free of random packing elements is provided.

7. Turbulent flow column according to claim 1, wherein at least one section of the turbulent flow column comprises an insert which has a porous base.

8. Turbulent flow column according to claim 13, wherein the insert has a circumventing edge element.

9. (canceled)

10. Turbulent flow column according to claim 1, wherein at least one downcomer is arranged in at least one section of the turbulent flow column.

11. Turbulent flow column according to claim 10, wherein a lower end of the downcomer is surrounded by a downcomer pan.

12. Turbulent flow column according to claim 7, wherein the base of the insert is formed by a lattice-like material.

13. Turbulent flow column according to claim 12, wherein the base of the insert is a meshed metal baffle.
